(19) United States
(12) Patent Application Publication
(10) Pub. No.: US 2007/0088587 A1
(43) Pub. Date: Apr. 19, 2007

(54) Delivery date simulation and control

(75) Inventors: Karina Normann Jakobsen, Frederikssund (DK); Niels Helgogaard, Copenhagen (DK)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/251,249

(22) Filed: Oct. 14, 2005

(51) Int. Cl. G06F 9/46

(52) U.S. Cl. 705/8

(57) ABSTRACT

A method and system for determining a merchant ship date and a corresponding customer receipt date when processing an order in an ERP system. The method includes accessing a delivery date simulation form stored in the ERP system during processing of the new order and changing an existing order. The method includes generating a list of alternative merchant ship dates and corresponding customer receipt dates to be displayed on the delivery date simulation form. The list of merchant ship dates and customer receipt dates are calculated based at least partially on customer parameters and at least partially on merchant parameters stored in a database of the ERP system. The method also includes transferring a selected merchant ship date and corresponding customer receipt date from the list of alternative merchant ship dates and corresponding customer receipt dates to the order.

### BACKGROUND

Enterprise resource planning (or ERP) is a phrase used to describe a broad set of activities supported by multi-module application software that helps a company or merchant manage the important parts of its business. Computerized ERP systems typically handle the logistics of various activity modules internal to a business or organization, such as accounting/financial management, customer relations management, supply chain management and human resource management. Often, an ERP system uses or is integrated with a relational database system. Examples of ERP system software packages include Microsoft® Business Solutions Axapta®, Navision® and Great Plains®.

ERP systems utilize a large number of files that are part of a collection of information that is stored in a database shared by the various management application modules. These files represent widely varying types of information, for example including information related to transactions such as sales orders, purchase orders and bill payments and information related to reference data, such as customer profiles and shipping parameters.

An example component of a Supply Chain Management module is a sales order management component. A sales order management component processes various types of transactions, such as sales orders and item returns. When generating a sales order, an order processor generally is required to give precise delivery dates to customers, such as a customer receipt date which is the date at which items ordered will be delivered to the customer. To determine a customer receipt date, various complex factors need to be considered. Example factors include internal handling time of the goods to be shipped, transportation and pickup time for a carrier (mode of delivery) to deliver the goods and the customer's ability to receive goods.

Typically, the determination of customer receipt dates is handled using a subsequent process. For example, an order processor of a merchant company can calculate customer receipt dates manually (i.e. date management using paper calendars) or can partially calculate customer receipt dates using a transportation management system (TMS). The level of complexity, however, makes it very difficult and inefficient for an order processor to determine a customer receipt date manually and in combination with the aid of a TMS. A TMS is typically used in a subsequent process after the order has been taken.

The discussion above is merely provided for general background information and is not intended to be used as an aid in determining the scope of the claimed subject matter.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Simulating customer receipt dates and merchant ship dates allows an order processor to determine an acceptable merchant ship date and a corresponding customer receipt date when processing an order. A delivery date simulator, simulating both receipt and ship dates, is accessed during order processing in an ERP system and displayed as a delivery date simulation form. A list of alternative merchant ship dates and corresponding customer receipt dates are generated based at least partially on customer parameters and merchant parameters stored in a database. One of the list of alternative customer receipt dates and merchant ship dates that complies with customer requirements is selected to be transferred to the order.

### BRIEF DESCRIPTION OF THE DRAWINGS

FIG. 1 is a block diagram of one computing environment in which some embodiments may be practiced.

FIG. 2 illustrates a simplified block diagram of an Enterprise Resource Planning (ERP) system.

FIG. 3 illustrates a simplified flowchart of a computer-implemented method of processing an order in an ERP system.

FIG. 4 is an example screenshot of a sales order form illustrating creation of a sales order.

FIG. 5 is an example screenshot of the sales order form of FIG. 4 illustrating a sales order line for the created sales order.

FIG. 6 is an example screenshot of the sales order form of FIG. 4 illustrating a setup tab for the sales order line of FIG. 5.

FIG. 7 illustrates a simplified flowchart of a computer-implemented method of determining an acceptable merchant ship date and a customer receipt date when processing an order in an ERP system.

FIG. 8 is an example screenshot of the sales order history form of FIG. 4 illustrating a delivery date simulation form.

FIG. 9 is an example screenshot of the sales order history form of FIG. 5 illustrating the delivery date simulation form of FIG. 8 and changing the mode of delivery.

FIG. 10 is an example screenshot of the sales order form of FIG. 5 illustrating the delivery date simulation form of FIG. 9 that includes a regenerated list of dates based on a changed mode of delivery.

### DETAILED DESCRIPTION

The following description is described in the context of an Enterprise Resource Planning (ERP) system that can manage many different business applications of a company or a merchant. Processes in an ERP system are performed in the form of transactions and documents. A transaction can be defined as an event or conduction of business that occurs between two parties, such as between a customer and a merchant. Transactions are organized into various types of modules such that each transaction is tracked. In addition, each transaction includes a certain look and feel and each transaction conveys certain information. For example, a sales order is a transaction that occurs between a customer and a merchant. A sales order is created and processed within a sales order management or account receivable component of the ERP system such that the sales order can be easily tracked and convey certain information.

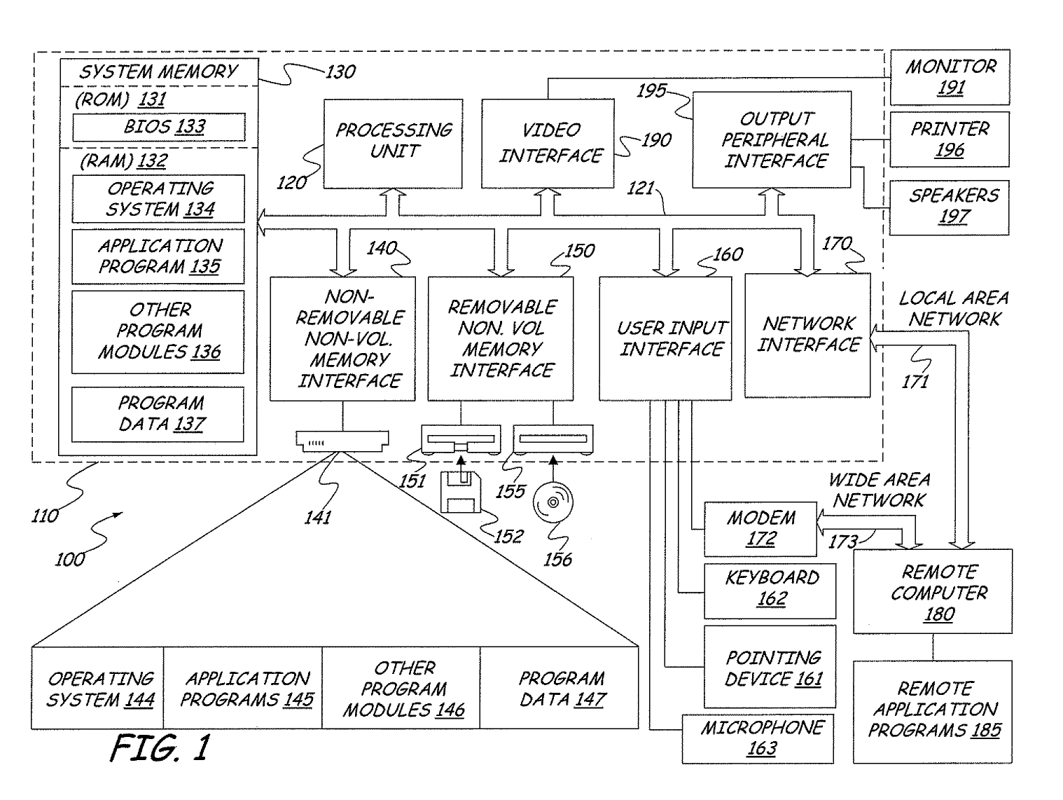

Before describing aspects of the illustrated embodiments, however, it may be useful to describe suitable computing environments that can incorporate and benefit from these aspects. ERP systems are typically implemented in a networked environment of server computers and/or other computers. The computing environment shown in FIG. 1 is one such example.

FIG. 1 illustrates an example of a suitable computing system environment 100 on which embodiments may be implemented. The computing system environment 100 is only one example of a suitable computing environment and is not intended to suggest any limitation as to the scope of use or functionality of the disclosed embodiments. Neither should the computing environment 100 be interpreted as having any dependency or requirement relating to any one or combination of components illustrated in the exemplary operating environment 100.

Embodiments are operational with numerous other general purpose or special purpose computing system environments or configurations. Examples of well-known computing systems, environments, and/or configurations that may be suitable for use with various embodiments include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

Embodiments may be described in the general context of computer-executable instructions, such as program modules, being executed by a computer. Generally, program modules include routines, programs, objects, components, data structures, etc. that perform particular tasks or implement particular abstract data types. Some embodiments are designed to be practiced in distributed computing environments where tasks are performed by remote processing devices that are linked through a communications network. In a distributed computing environment, program modules are located in both local and remote computer storage media including memory storage devices.

With reference to FIG. 1, an exemplary system for implementing some embodiments includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 is operated in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

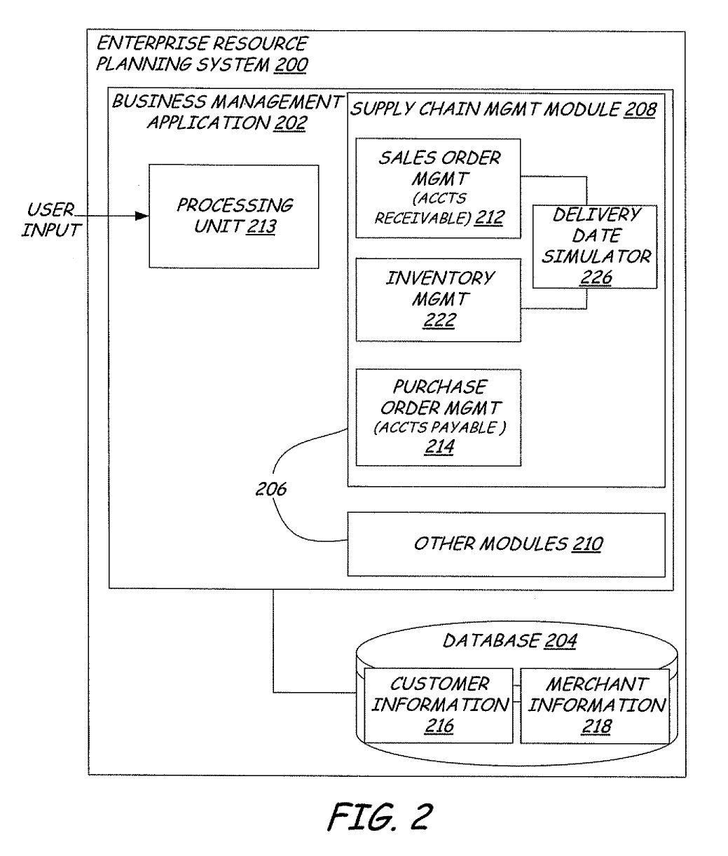

FIG. 2 is a block diagram illustrating an Enterprise Resource Planning system (ERP) 200. ERP system 200 includes a business management application 202 and a database 204. Business management application 202 includes a plurality of modules 206. Each module 206 includes particular types of components. As illustrated in FIG. 2, an example module includes a Supply Chain Management module 208. Other example modules are represented by module 210 and include other management type modules, such as a customer relation management module, a financial module and a human resource management module. Each management module includes transactions that document an event or a conduction of business that occurs specific to the module of which it belongs. The Supply Chain Management module 208 includes components that manage transactions specific to sales, purchases and inventory. Sales order management component 212 is where sales orders are created and processed, inventory management component 222 is where transfer orders are created and processed and purchase order management component 214 is where purchasing transactions are created and processed. Components 212, 222, and 214 are suitably programmed processing components. A sales order is a transaction that is created by a user or order processor such that ERP system 200 can document and track items or goods ordered by a customer. Sales order management component 212 can also document and track items or goods ordered by a customer through a release order. A release order is a semi-automatically generated order that is based on an agreement between a merchant and a customer to order certain items or goods on a periodic basis. A transfer order is a transaction that is created by a user or order processor such that the ERP system 200 can document and track items and goods (i.e. inventory) that are transferred from one merchant warehouse to another merchant warehouse.

Business management application 202 also includes a processing unit 213. Processing unit 213 is configured to receive an input from a user. Processing unit 213 is also configured to communicate with database 204. Information in database 204 is made available to a user. Information stored in database 204 can include, but is not limited to, customer parameters in customer information 216 and merchant parameters in merchant information 218. These types of information are useful when processing a sales order transaction or other type of order transaction in supply chain management module 208. In turn, processing unit 213 allows a user to select data, such as data from customer information 216 and merchant information 218, in database 204. In one embodiment, customer information 216 and merchant information 218 are made available to a user by displaying the information on a display screen.

Supply Chain Management module 208 also includes a delivery date simulator 226. Delivery date simulator 226 is accessible by both sales order management component 212 and inventory management component 222. Delivery date simulator 226 is a component that includes computer-executable instructions for determining alternative merchant ship dates and corresponding customer receipt dates for an order. Delivery date simulator 226 is useful when the user enters an earliest merchant ship date and a corresponding earliest customer receipt date that are unsatisfactory to a customer. Delivery date simulator 226 will be discussed in detail below.

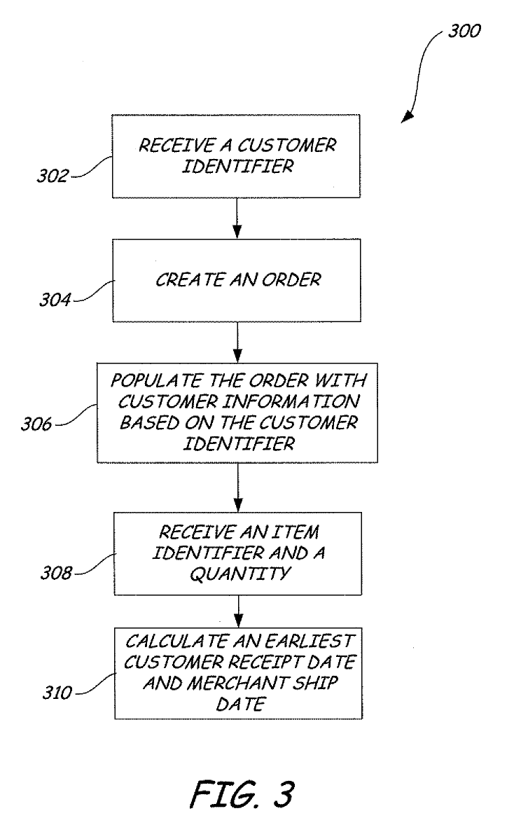

FIG. 3 illustrates a simplified flowchart 300 of a computer-implemented method of processing an order in an ERP system. At block 302, an ERP system, such as ERP system 300 illustrated in FIG. 3, receives a customer identifier from a user or order processor. In general, a customer identifier is a customer number that is associated with a particular customer. Once a customer identifier is received, customer information is retrieved that coincides with the customer. At block 304, the ERP system is instructed to create a new order for the particular customer.

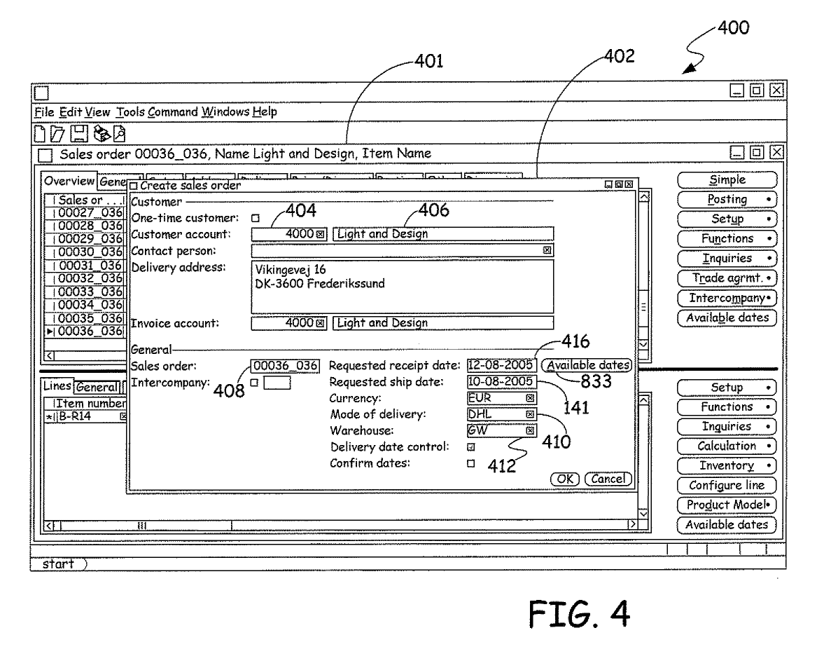

FIG. 4 is an example screenshot 400 of a sales order form 401 illustrating a wizard 402 for creating a sales order. Wizards exist in most software products and allow users to access and assemble the tools needed for establishing a functionality in a task-oriented way. In this instance, sales order wizard 402 allows a user to easily create a sales order. Those skilled in the art should recognize that creating an order is not limited to creating a sales order. Other types of orders can be created, such as release orders and quotation orders. A quotation order is an order that quotes prices of particular goods for a potential customer. As illustrated in FIG. 4, create sales order wizard 402 is superimposed over sales order form 401. Sales order form 401 includes a list of historically created sales orders for one or more customers.

At block 306, the ERP system populates the create sales order wizard 402 with customer parameters and merchant parameters which are retrieved from customer information and merchant information (i.e. customer information 216 and merchant information 218 of FIG. 2) stored in a database (i.e. database 204 of FIG. 2). Customer parameters are retrieved from the database based on the received customer identifier. At least some of the customer parameters and merchant parameters include default parameters. Customer parameters and merchant parameters displayed on create sales order wizard 402 include a customer identifier or customer account number that populates field 404, a customer name that populates field 406, a sales order number that populates field 408 for the created sales order, a default mode of delivery that populates field 410 and a default merchant ship from warehouse that populates field 412. Based at least partially on the retrieved default customer parameters and merchant parameters, and the entered provisional customer requested receipt date (field 416) the ERP system calculates a provisional merchant ship date displayed in field 514. Merchant ship date 414 and customer receipt date 416 are provisional dates, since some of the default customer and merchant parameters are based on items or goods that have yet to be entered or selected by the order processor.

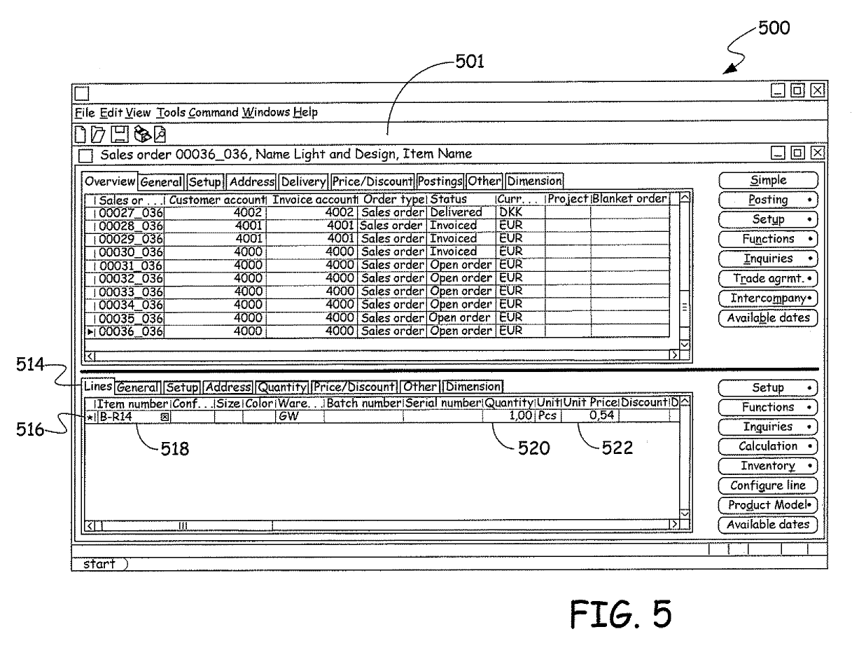

At block 308, the ERP system receives at least one item identifier and corresponding quantity. The item identifier identifies what types of goods are being ordered by the customer. FIG. 5 is an example screenshot 500 of sales order form 401 of FIG. 4 illustrating details of the sales order created in block 304. As illustrated in FIG. 5, screenshot 500 displays a tab 514 that includes a sales order line 516. Sales order line 516 includes an item identifier or item number that is entered in field 518, a quantity that is entered in field 520 and a price that is entered in field 522.

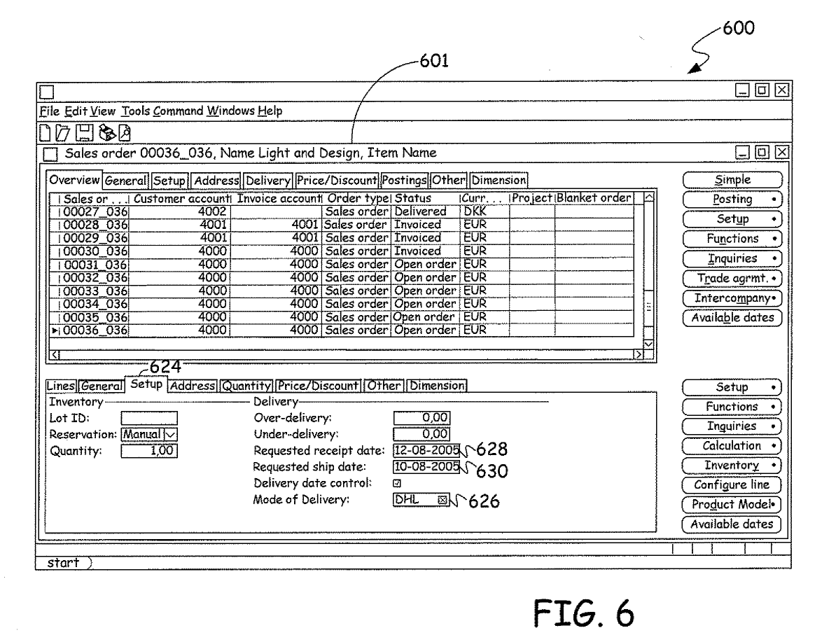

At block 310, the ERP system calculates an earliest customer receipt date and a corresponding earliest merchant ship date based on updated default customer and merchant parameters based on the item identifier and item quantity illustrated in FIG. 5. FIG. 6 illustrates an example screenshot 600 of sales order form 401 of FIG. 4 illustrating details of the sales order created in block 304. As illustrated in FIG. 6, screenshot 600 displays setup tab 624 that includes a default mode of delivery that populates field 626, a calculated earliest customer receipt date displayed in field 628 and a calculated earliest merchant ship date displayed in field 630.

In the example sales order illustrated in FIGS. 4-6, the order processor created the sales order on Monday, Aug. 8, 2005 at 15:00. Merchant policy is that all orders entered after 11:00 will not be processed before the subsequent workday. Therefore, the sales order created on Monday, Aug. 8, 2005 will not be processed before Tuesday, Aug. 9, 2005. Such a merchant policy is stored in merchant information (i.e. merchant information 218 of FIG. 2) as a default. The default merchant handling or lead time in the example sales order in FIGS. 4-6 is one day. Therefore, since the order will not be processed before Tuesday, Aug. 9, 2005, then adding one day will make the sales order shippable on Wednesday, Aug. 10, 2005. Since, the default merchant warehouse illustrated in field 512 of FIG. 5 is open for pickup on all weekdays and since the default mode of delivery illustrated in field 410 of FIG. 4 and field 626 of FIG. 6 is able to pickup on all weekdays as well, the earliest merchant ship date illustrated in field 630 is Wednesday, Aug. 10, 2005. It takes the default mode of delivery 2 days to transport the ordered items from the merchant warehouse to the customer warehouse. Therefore, the earliest customer receipt date illustrated in field 628 is Friday, Aug. 12, 2005. For the purposes of illustration, while the order processor is processing the sales order, he or she determines that a Friday, Aug. 12, 2005 customer receipt date is unsatisfactory for the customer.

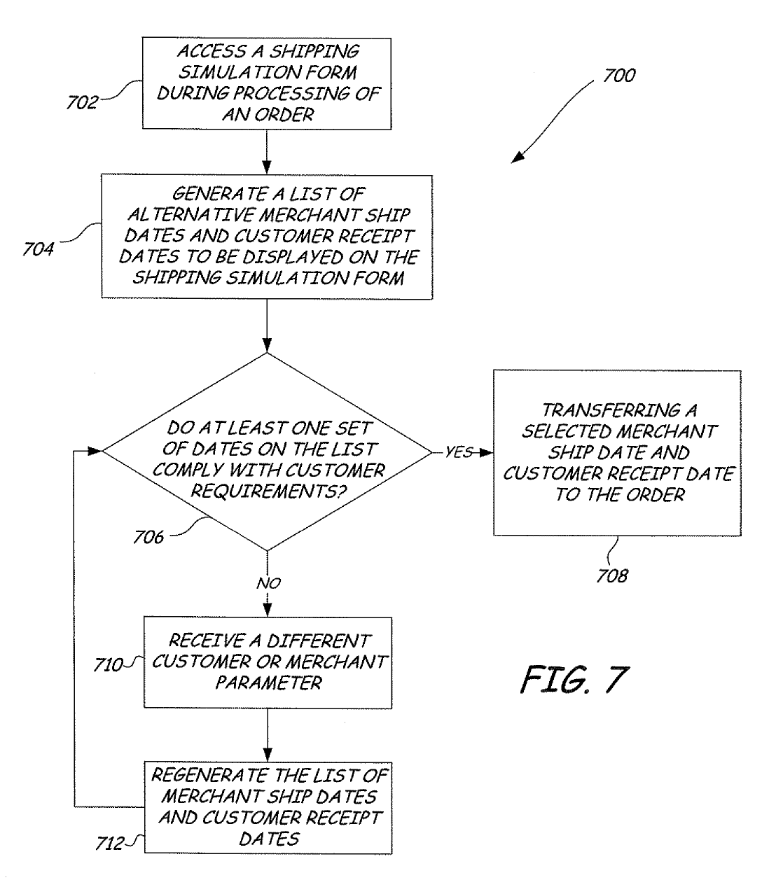

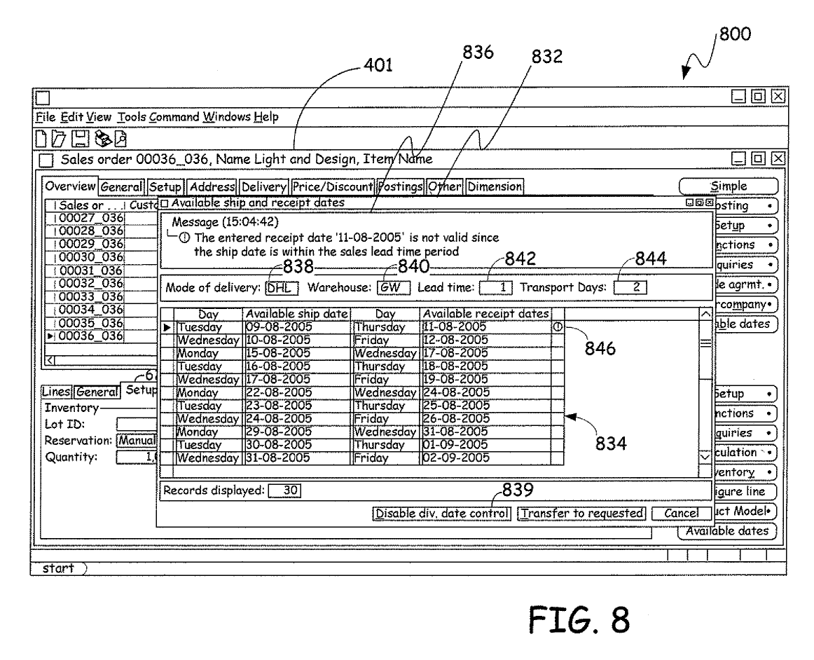

FIG. 7 illustrates a simplified flowchart of a computer-implemented method of determining an acceptable merchant ship date and a corresponding acceptable customer receipt date when processing a new order in an ERP system. At block 702, the ERP accesses a delivery date simulator, such as delivery date simulator 226 illustrated in FIG. 2. The delivery date simulator is displayed as a delivery date simulation form during processing of the new order. FIG. 8 illustrates an example screenshot 800 of the sales order history form of FIG. 4 illustrating a delivery date simulation form 832. Delivery date simulation form 832 is accessible while processing a new sales order and is superimposed over sales order form 401 of FIG. 4. Delivery date simulation form 832 can be automatically accessed in various ways. In one embodiment, delivery date simulation form 832 can be accessed upon receiving a different customer receipt date than the calculated earliest customer receipt date as illustrated in FIG. 6. In the example sales order illustrated in FIGS. 4-6 and 8, the calculated earliest customer receipt date of Friday, Aug. 12, 2005 is unsatisfactory to the customer. To access delivery date simulation form 832 in FIG. 8, the order processor can change the calculated earliest customer receipt date to a date that the customer needs the ordered items. For example, the customer may need the items on Thursday, Aug. 11, 2005. Upon the order processor entering the customer required date into the customer receipt date field 628 on setup tab 624, delivery date simulation form 832 is automatically accessed and displayed. In another embodiment, delivery date simulation form 832 can be accessed upon receiving an indication from a user or order processor to access the form. In the example sales order illustrated in FIGS. 4-6 and 8, the calculated earliest customer receipt date of Friday, Aug. 12, 2005 is unsatisfactory to the customer. To access delivery date simulation form 832 in FIG. 8, the ERP receives an indication from a user or order processor to access the form. For example, the order processor can select an “Available dates” button as a way of indicating to the ERP system that delivery date simulation form 802 should be accessed. Such a button is illustrated in FIG. 4 as indicated at 833.

At block 704, the delivery date simulator of the ERP system generates a list 834 of alternative merchant ship dates and corresponding customer receipt dates that are displayed on delivery date simulation form 832 of FIG. 8. The merchant ship dates and corresponding customer receipt dates are alternatives to the earliest merchant ship date and corresponding customer receipt date calculated in block 310 of FIG. 3. In addition to displaying list 834, delivery date simulation form 832 also includes a message box 836, a default mode of delivery displayed in field 838, a default merchant warehouse displayed in field 840, a default merchant handling or lead time displayed in field 842 and an amount of time that the mode of delivery will need to transport the items displayed in field 844. In addition to list 834 including columns of alternative customer receipt dates and corresponding merchant ship dates, list 834 also includes an invalid indicator 846 next to those customer receipt dates and corresponding merchant ship dates that are problematic. By highlighting a particular customer receipt date and corresponding merchant ship date with an invalid indicator 846, message box 836 includes a description explaining the reason why the particular customer receipt date and corresponding merchant ship date are problematic. In the example sales order illustrated in FIG. 4-6 and 8, a customer receipt date of Thursday, Aug. 11, 2005 is invalid because, as indicated in message box 836, the merchant ship date is within the merchant handling or lead time period.

At block 706, it is determined whether at least one customer receipt date and corresponding merchant ship date on the generated list comply with customer requirements. If at least one customer receipt date and corresponding merchant ship date comply with customer requirements, then the user may choose to transfer a selected one of the customer receipt date and corresponding merchant ship date to the new order that complies with customer requirements. If, however, none of the customer receipt dates and corresponding merchant ship dates comply with customer requirements, then the user may make a change in the parameter setting (mode of delivery and ship from warehouse) and thus simulate the effect that this will have on the feasible ship dates. In the sales order example illustrated in FIGS. 4-6 and 8, the customer requires that the goods be received on Aug. 11, 2005 in which all alternatives are in conflict with the customer requested receipt date as illustrated in delivery date simulation form 832. In this instance, the order processor can select a different customer or merchant parameter that is different than a default customer or merchant parameter in one of the fields on the sales order, or choose to project the customer receipt date into a feasible future date from the generated list. In one embodiment, the order processor can select a different merchant warehouse in merchant warehouse field 840 that is closer to the shipping location of the customer. In another embodiment, the order processor can select a different mode of delivery in mode of delivery field 838. The user can also choose to by-pass all rules by selecting a disable delivery date control 839, the user then has access to manually set the customer receipt date and the merchant ship date.

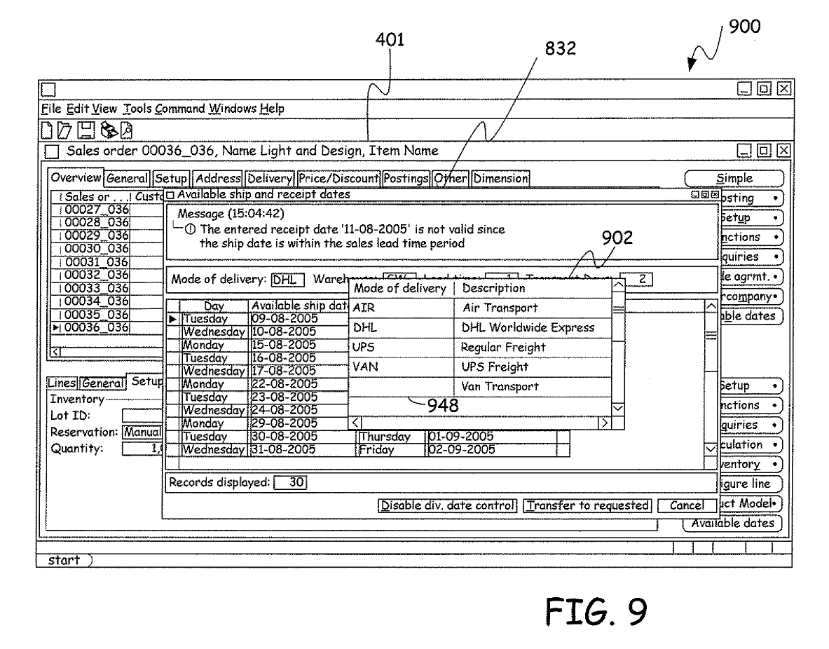

FIG. 9 is an example screenshot 900 of the sales order form 401 of FIG. 4 illustrating delivery date simulation form 832 of FIG. 8 and a mode of delivery drop down menu 902. As illustrated in FIG. 9, mode of delivery drop down menu 902 is superimposed over delivery date simulation form 832, which is superimposed over sales order form 401. The order processor can easily select a different mode of delivery from the list of mode of deliverers 948 that are displayed on mode of delivery drop down menu 902. In the example sales order illustrated in FIGS. 4-6 and 8-9, the order processor selects UPS as the mode of delivery instead of the default mode of delivery. Upon the ERP system receiving a different customer or merchant parameter, the method passes to block 712 and regenerates the list of merchant ship dates and corresponding customer receipt dates.

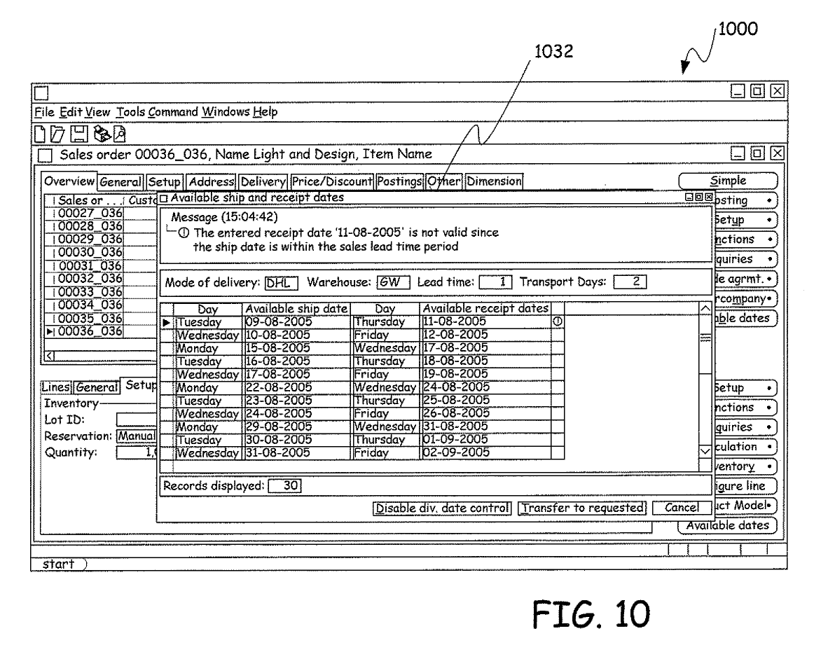

FIG. 10 illustrates an example screenshot 1000 of a regenerated delivery date simulation form 1032. In the sales order example illustrated in FIGS. 4-6 and 8-9, the customer requires that the goods be received on Aug. 11, 2005. Regenerated delivery date simulation form 1032 shows that a merchant ship date of Aug. 10, 2005 and a customer receipt date of Aug. 11, 2005 is feasible and available for selection. The user is able to select and accept the simulation result. The user transfers a selected one of the merchant ship dates and corresponding customer receipt dates to the new order that complies with customer requirements. In this case, the ERP system transfers the merchant ship date of Aug. 10, 2005 and the customer receipt date of Aug. 11, 2005 as selected by the order processor.

If, however, the regenerated list still does not comply with customer requirements, the user could continue to pass to block 710 and continue to regenerate the list of alternatives in block 712 until one of the alternatives complies with customer requirements.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method of determining an acceptable merchant ship date and a customer receipt date when processing an order in an ERP system, the method comprising:
accessing a delivery date simulation form stored in the ERP system during processing of the order;
generating a list of alternative merchant ship dates and corresponding customer receipt dates to be displayed on the delivery date simulation form, wherein the list of alternative merchant ship dates and customer receipt dates are calculated based at least partially on customer parameters and at least partially on merchant parameters stored in a database of the ERP system; and
transferring a selected merchant ship date and corresponding customer receipt date from the list of alternative merchant ship dates and corresponding customer receipt dates to the order.

2. The computer-implemented method of claim 1 and further comprising:
determining that none of the generated list of alternative merchant ship dates and corresponding customer receipt dates comply with customer requirements;
receiving one of a different customer parameter and a different merchant parameter; and
regenerating the list of alternative merchant ship dates and corresponding customer receipt dates based on one of the different customer parameter and the different merchant parameter before transferring the selected merchant ship date and corresponding customer receipt date to the order.

3. The computer-implemented method of claim 2, wherein the different merchant parameter comprises a merchant warehouse that is different than a merchant warehouse used in the list of alternative merchant ship dates and corresponding customer receipt dates.

4. The computer implemented method of claim 2, wherein the different customer parameter comprises a mode of delivery that is different than a mode of delivery used in the list of alternative merchant ship dates and corresponding customer receipt dates.

5. The computer-implemented method of claim 2 and further comprising repeating the steps of determining, receiving and regenerating to obtain a different list of alternative merchant ship dates and corresponding customer receipt dates.

6. The computer-implemented method of claim 1, wherein the order is one of a sales order, quotation, item requirement, transfer order and a release order.

7. The computer-implemented method of claim 6, wherein if the order is the transfer order, then the customer receipt dates comprise dates that a merchant warehouse is able to receive goods and are not receipt dates based on customer parameters.

8. The computer-implemented method of claim 1, wherein accessing a delivery date simulation form comprises automatically accessing the delivery date simulation form upon receiving a different customer receipt date than a calculated earliest customer receipt date.

9. The computer-implemented method of claim 1, wherein accessing a delivery date simulation form comprises automatically accessing a delivery date simulation form upon receiving an indication from a user to access the form.

10. The computer-implemented method of claim 1, wherein generating the list of alternative merchant ship dates and corresponding customer receipt dates comprises generating an invalid indicator next to merchant ship dates and corresponding customer receipt dates that are problematic.

11. The computer-implemented method of claim 10, further comprising displaying, in a message box on the delivery date simulation form, a description explaining the reason that certain merchant ship dates and corresponding customer receipt dates are problematic.

12. A computer implemented method of processing an order in an ERP system, the method comprising:
receiving a customer identifier;
populating the order with customer parameters based on the customer identifier;
receiving an item identifier and a quantity;
calculating if the requested customer receipt date and ship date is feasible based at least partially on the customer parameters and at least partially on merchant parameters;
automatically accessing a delivery date simulation form if the requested receipt date and ship date are not feasible;
generating a list of alternative merchant ship dates and customer receipt dates on the delivery date simulation form based at least partially on the customer parameters and at least partially on the merchant parameters; and
transferring a selected merchant ship date and corresponding customer receipt date from the list of alternative merchant ship dates and corresponding customer receipt dates to the order.

13. The computer-implemented method of claim 12, and further comprising:
determining that none of the generated list of alternative merchant ship dates and corresponding customer receipt dates comply with customer requirements;
receiving one of a different customer parameter and a different merchant parameter; and
regenerating the list of alternative merchant ship dates and corresponding customer receipt dates based on one of the different customer parameter and the different merchant ship date before transferring the selected merchant ship date and corresponding customer receipt date to the order.

14. The computer-implemented method of claim 12, wherein accessing the delivery date simulation form comprises accessing the delivery date simulation form upon receiving a different and earlier customer requested receipt date than the calculated earliest feasible customer receipt date.

15. The computer-implemented method of claim 12, wherein accessing the delivery date simulation form comprises accessing the delivery date simulation form upon receiving an indication from the user to access the shipping simulation form.

16. An Enterprise Resource Planning (ERP) system for use in managing business applications comprising:
a transactional application configured to manage and process an order;
a database including customer information that stores customer parameters and merchant information that stores merchant parameters; and
a delivery date simulator accessible during order processing, the delivery date simulator configured to calculate and display alternative customer receipt dates and corresponding merchant ship dates based at least partially on the customer parameters and at least partially on the merchant parameters.

17. The ERP system of claim 16, wherein the transactional application comprises a sales order management application configured to process sales orders and release orders.

18. The ERP system of claim 16, wherein the transactional application comprises an inventory management application configured to process transfer orders.

19. The ERP system of claim 16, wherein the delivery date simulator is configured to recalculate and redisplay alternative customer receipt dates and corresponding merchant ship dates based on obtaining one of a different customer parameter and a different merchant parameter.

20. The ERP system of claim 16, wherein the delivery date simulator is configured to recalculate and redisplay alternative customer receipt dates and corresponding merchant ship dates if customer requirements are not satisfied in the first calculation.
